(19) United States
(12) Patent Application Publication
(10) Pub. No.: US 2025/0015990 A1
(43) Pub. Date: Jan. 9, 2025

(54) METHOD FOR DETECTING MANIPULATION OF DATA IN A NETWORK

(71) Applicant: Endress+Hauser Flowtec AG, Reinach (CH)

(72) Inventors: Nikolai Fink, Aesch (CH); Mathis Zeiher, Lörrach (DE); Ervin Binkert, Möhlin (CH)

(21) Appl. No.: 18/709,669

(22) PCT Filed: Nov. 7, 2022
(86) PCT No.: PCT/EP2022/080895

§ 371 Date: May 13, 2024

(30) Foreign Application Priority Data
Nov. 11, 2021 (DE) 10 2021 129 430.4

(51) Int. Cl. H04L 9/14; H04L 9/32

(52) U.S. Cl. CPC H04L 9/14; H04L 9/3247

(57) ABSTRACT

A method for detecting data manipulation of a field device is disclosed, said data being sent in the form of data packets using a communication channel. The field device is part of a secure sub-network. The sub-network includes the field device or an edge device and the field device. In a first step, a device key pair having a private device key and a public device key is generated using an asymmetric cryptosystem, where the private device key is stored in a signing sub-network device. In a second step, the signing sub-network device generates, for a group of data packets comprising data packets, a digital data signature using the private device key and transmits said digital data signature and the data packets to the receiving device. In a third step, the receiving device verifies the data packets using the associated data signature and the public device key.

The invention relates to a method for detecting manipulation of data sent in a network comprising a measurement/automation field device and a receiving device.

Data can be transmitted securely, for example by encryption and subsequent decryption in a network, see for this purpose DE202006000817T2. However, there is often no interest in secret transmission; rather, there is an interest in the certainty that data has not been subsequently changed. In addition, encryption and subsequent decryption requires knowledge of the public keys of each data recipient.

Therefore, the object of the invention is to propose a method with which data is provided in a network in a verifiable, simple and robust manner.

The object is achieved by a method according to independent claim 1.

With a method according to the invention for detecting manipulation of data of a measurement/automation field device, said data being sent in the form of data packets within a network via an unsecure communication channel to a receiving device,
wherein the field device is part of a secure sub-network formed by at least one sub-network device, which sub-network comprises at least the measurement/automation field device or an edge device and at least the measurement/automation field device,
wherein, by means of an asymmetric cryptosystem,
in a first method step, a device key pair having a private device key and having a public device key is generated, wherein the private device key is stored in a signing subnet device,
wherein, in a second method step, the signing sub-network device generates, for a group of data packets comprising at least one data packet, a digital data signature by means of the private device key and transmits said digital data signature and the group of data packets to the receiving device,
wherein, in a third method step, the receiving device the group of at least one data packet by means of a The digital data signature and the associated group of data packets can be transmitted together or independently of one another.

The signing sub-network device of the network is, for example, a measurement/automation field device or an edge device.

The data can comprise, for example, measurement data and/or device characteristics from a measurement/automation field device.

A cryptosystem such as RSA or ECC (elliptic curve cryptography) can be used as an asymmetric cryptosystem. The expert uses a cryptosystem of their choice. This takes advantage of the fact that a private key can be used to create a signature for data, which data can then be verified with the aid of the signature and a public key belonging to the private key.

It is essential for the invention that the data to be transmitted is digitally signed by means of the private device key and can therefore be verified by means of the public device key.

In one embodiment, the affiliation of data groups and digital data signatures is documented by means of time stamps.

In one embodiment, the generation of the digital data signature can be applied to a hash value of the group of data packets to increase security.

In one embodiment, a master key pair with a private master key and a public master key is also generated, wherein the public device key can be verified by means of the public master key, and wherein the private device key is stored in the signing sub-network device,
wherein a digital key signature is created for the public device key by means of the private master key for the verifiability of the public device key by means of the public master key, wherein the receiving device verifies the public device key by means of the public master key. The digital key signature can be sent together with the public device key or the digital key signature can be attached to the public device key.

It is advantageous if the data to be transmitted is digitally signed by means of the private device key and the public device key used to verify the data can itself be verified. In this way, a security chain can be set up that can be checked at any time and by anyone so that an undetectable manipulation of the data is ruled out from a practical point of view.

In this way, a security chain can be set up that can be checked at any time and by anyone so that an undetectable manipulation of the data is ruled out from a practical point of view.

In this way, the security chain can be guaranteed by the owner of the private device key, for example by the manufacturer of the measurement/automation field device.

In one embodiment, the digital key signature of the public device key is provided by a sub-network device, in particular by the signing sub-network device. Thus, by means of the public master key, anyone can verify the public device key and thus subsequently the transmitted data.

In one embodiment, the private device key is stored in the signing sub-network device in a secure manner, for example by means of a TPM (Trusted Platform Module) chip.

In one embodiment, the signing sub-network device is a measurement/automation technology field device or an edge device in a network with at least one such field device.

There may be an increased interest in security against manipulation for data that is created by such devices or passed on to an external communication channel, since this relates, for example, to the measurement of a medium for sale, such as oil or beer.

In one embodiment, the public device key is provided via the channel so that it is publicly available.

In one embodiment, to further increase security, a group of data packets with the same content can be set up to require the same hash values.

In one embodiment, the master key pair is generated by the manufacturer of the signing sub-network device or the measurement/automation field device.

In one embodiment, the device key pair is predefined, for example by a manufacturer of a TPM chip, or is created during the production of the signing sub-network device.

In one embodiment, the device key pair is generated by the manufacturer of the signing sub-network device or by the signing sub-network device itself.

The invention will now be described with reference to exemplary embodiments.

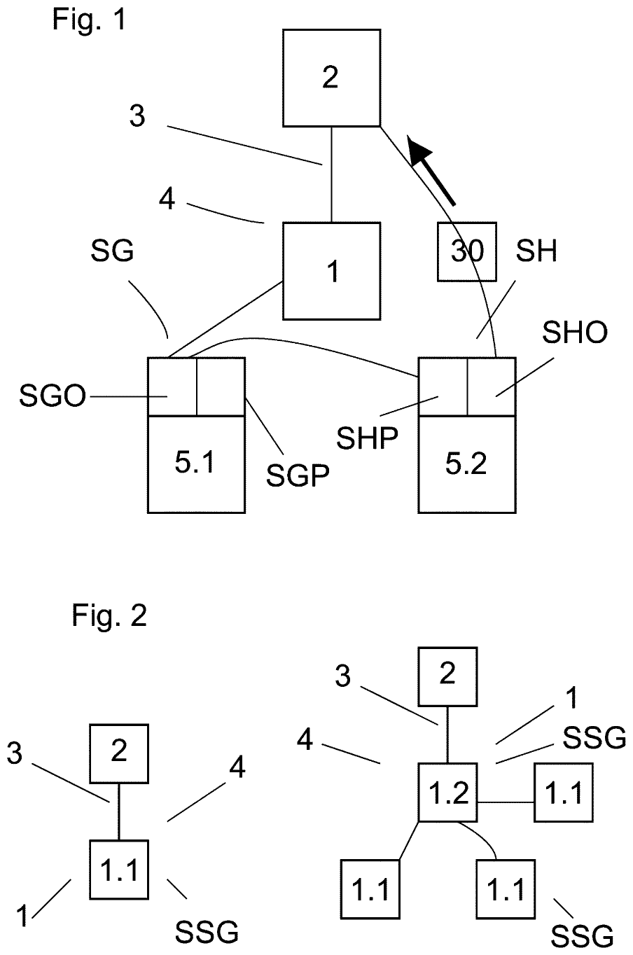

FIG. 1 describes an exemplary system according to the invention for implementing the method according to the invention;

FIG. 2 outlines exemplary networks;

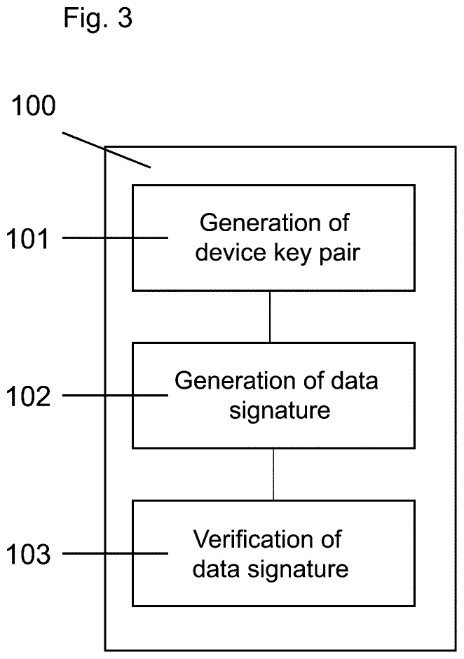

FIG. 3 describes an exemplary method according to the invention;

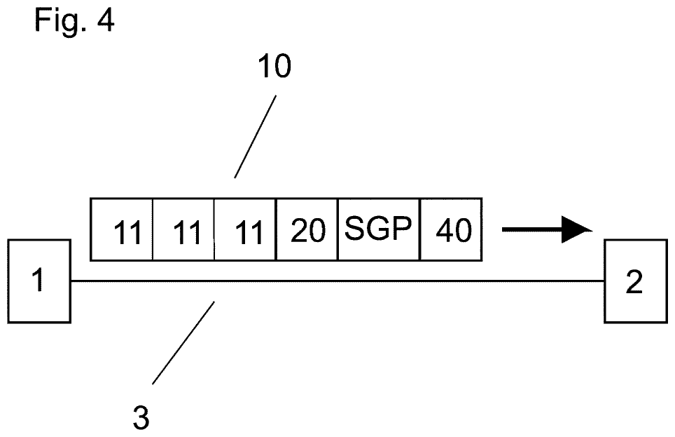

FIG. 4 describes an exemplary structure of data packets to be transmitted.

FIG. 1 describes an exemplary system according to the invention for implementing the method according to the invention comprising a secure sub-network 1, from which sub-network data such as measurement data from a measurement/automation field device 1.1 (see FIG. 2) is transmitted to a receiving device 2 in the form of data packets 11 by means of a communication channel 3, for example an unsecure communication channel. A generator 5.1 of a device key pair provides the device key pair SG with a public device key SGO and a private device key SPG to a signing sub-network device SSG. The signing sub-network device is set up to sign this data from field device 1.1 with the private device key. The signing sub-network device SSG can be the field device 1.1 or an edge device 1.2 (see FIG. 2), which, if present, is set up to enable communication between field devices 1.1 of sub-network 1 and the receiving device 2.

In one embodiment, as shown here, a generator 5.2 of a master key pair with a public master key SHO and a private master key SHP can provide the public master key SHO in the network. Both key pairs are based on an asymmetric cryptosystem such as RSA or ECC (elliptic curve cryptography) or a method derived from these. In addition, a digital key signature 30 of the public device key can be created and transmitted to a receiving device, for example.

FIG. 2 shows two different exemplary networks 4 comprising a secure sub-network 1 of the network, wherein the secure sub-network is connected to the receiving device 2 via the communication channel 3, for example an unsecure communication channel. In its simplest form, the secure sub-network 1 can, for example, comprise a single measurement/automation field device, which determines and provides measured values for a measured variable and, if necessary, transmits this measured variable with device information in the form of data packets to the receiving device. However, the secure sub-network 1 can also comprise multiple devices, such as an edge device 1.2, to which one or more field devices 1.1 described above, in this example three, are connected.

The generator of the device key pair 5.1 and the generator of the master key pair 5.2 can be different or the same, the key pairs are different. For example, the generator of the device key pair can be a manufacturer of a security chip such as a TPM module and the generator of the master key pair can be a manufacturer of the edge device or field device. For example, the manufacturer of the edge device or the field device can also be the generator of both key pairs.

By means of the private device key a digital data signature 20 for a group of data packets 10 (see also FIG. 4) comprising at least one data packet 11 can be created, which can be verified by the public device key. The digital data signature can be applied to the group itself or to a hash value of the group. Verification of the group of data packets means applying the public device key SGO to the data signature and comparing the resulting group or its hash value with the directly issued group or its hash value. The digital data signature is created by a signing sub-network device SSG of the secure sub-network 1.1, for example by a data-generating field device 1.1 or by the edge device 1.2.

In one embodiment, the public device key SGO can itself be verified by the public master key SOH. For example, a digital key signature 30 is created for the public device key by means of the private master key. The digital key signature 30 can, for example, be attached to the public device key and made available to the receiving device or a user of the receiving device.

The receiving device or an operator of the receiving device can then verify the group of data packets by means of the public device key as well as verify the public device key itself by means of the digital key signature and the public master key.

For example, multiple private device keys can be provided to the signing sub-network device for generating the digital data signatures 20 so that, on occasion or when necessary, a private device key used at a point in time can be declared invalid and replaced by a new private device key. The public device key associated with a private device key can be provided by the signing sub-network device or otherwise. For example, the public device key can be legibly attached to the housing of a receiving device. This can be achieved, for example, by means of a plaque or a sign.

FIG. 3 outlines the sequence of an exemplary method 100 according to the invention, wherein a device key pair SG with a public device key SGO and a private device key SGP is generated in a first method step 101.

The private device key and, in particular, the public device key are stored in a signing sub-network device to generate the data signature. The private device key is kept secret by this signing sub-network device, wherein the public device key is provided by the signing sub-network device, for example. In a second method step 102, a digital data signature is created for the group of data packets, which can, for example, be attached to the group of data packets or sent separately. In a third method step 103, the group of data packets is verified with the aid of the public device key.

In one embodiment, as already mentioned, the public device key can be verified by means of the public master key, so that there is no justification for attempting to manipulate the data to be transmitted. For this purpose, a master key pair SH with a public master key SHO and a private master key SHP is generated and the public device key is signed with the private master key. The public device key is signed before the second method step is executed, in order to prevent manipulation of the private master key. The master key pair can, for example, exist independently of the method steps or be generated during the carrying out of the method.

For security reasons, verification of the public master key can be carried out occasionally or regularly, but is not absolutely necessary.

FIG. 4 outlines a purely exemplary structure of a group of data packets 10 transmitted via the communication channel 3 with a number of at least one data packet 11, here for example three. The digital signature 20 for the group and the public device key SGO can be attached to the group 10. For example, a time stamp 40 can also be attached. However, the digital signature 20 and/or the public device key and/or the time stamp can also be transmitted separately.

### LIST OF REFERENCE SIGNS

1 Secure sub-network
1.1 Field device of measurement/automation technology
1.2 Edge device
2 Receiving device
3 Communication channel
4 Network
5.1 Generator of the device key pair
5.2 Generator of the master key pair
10 Group of data packets
11 Data packet
20 Digital data signature
30 Digital key signature
40 Timestamp
100 Method for detecting manipulation
101 First method step
102 Second method step
103 Third method step
SG Device key pair
SGP Private device key
SGO Public device key
SH Master key pair
SHP Private master key
SHO Public master key
SSG Signing sub-network device

1-11. (canceled)

12. A method for detecting manipulation of data of a measurement/automation field device, said data being sent in the form of data packets within a network using a communication channel to a receiving device,
wherein the field device is part of a secure sub-network formed by at least one sub-network device, said sub-network comprising at least the measurement/automation field device or an edge device and at least the measurement/automation field device,
wherein, by means of an asymmetric cryptosystem,
the method including:
in a first method step, a device key pair having a private device key and having a public device key is generated, wherein the private device key is stored in a signing sub-network device;
in a second method step, the signing sub-network device generates, for a group of data packets comprising at least one data packet, a digital data signature by means of the private device key and transmits said digital data signature and the group of data packets to the receiving device; and
in a third method step, the receiving device verifies the group of at least one data packet by means of the associated data signature and the public device key.

13. The method according to claim 12,
wherein an affiliation of data groups and digital data signatures is documented by means of time stamps.

14. The method according to claim 12,
wherein the generation of the digital data signature is applied to a hash value of the group of data packets.

15. The method according to claim 12,
wherein the public device key is provided via the communication channel.

16. The method according to claim 12,
wherein a master key pair with a private master key and a public master key is generated,
wherein the public device key can be verified by means of the public master key,
wherein, for the verifiability of the public device key by means of the public master key,
a digital key signature is created for the public device key by means of the private master key,
wherein the receiving device verifies the public device key by means of the public master key.

17. The method according to claim 15,
wherein the digital key signature of the public device key is provided by a sub-network device, in particular by the signing sub-network device.

18. The method according to claim 12,
wherein the private device key is stored in a secure manner in the signing sub-network device.

19. The method according to claim 12,
wherein groups of data packets with the same content require the same hash values.

20. The method according to claim 12,
wherein the master key pair is managed by a manufacturer of a sub-network device.

21. The method according to claim 12,
wherein the device key pair is predefined.

22. The method according to claim 12,
wherein the device key pair is generated by the manufacturer or by a sub-network device.
